(19) United States
(12) Patent Application Publication
(10) Pub. No.: US 2024/0404112 A1
(43) Pub. Date: Dec. 5, 2024

(54) SMOOTH VIDEO/IMAGE SIGNAL COMPRESSION

(71) Applicant: Apple Inc., Cupertino, CA (US)

(72) Inventors: Khaled Mammou, Danville, CA (US); Alexandros Tourapis, Los Gatos, CA (US); Jay Mayur Khandhar, Milpitas, CA (US); Kristian D. Pereira, San Jose, CA (US); Borna Ghavam, San Francisco, CA (US)

(21) Appl. No.: 18/677,779

(22) Filed: May 29, 2024

Related U.S. Application Data
(60) Provisional application No. 63/470,491, filed on Jun. 2, 2023.

(51) Int. Cl. G06T 9/00

(52) U.S. Cl. CPC G06T 9/00

(57) ABSTRACT

Various implementations disclosed herein include devices, systems, and methods that enable compression of two-dimensional (2D) map-based video content. For example, a process may obtain (2D) data sets corresponding to different attributes of three-dimensional (3D) content. Each of the 2D data sets may provide attribute values for locations within a common 2D coordinate system that associates the attribute values for the different attributes with respective portions of the 3D content. The process may further generate a single 2D image by combining the 2D data sets. The attribute values corresponding to the different attributes may be combined with the single 2D image. The process may further encode the single 2D image into a specialized format for transmission or storage.

### CROSS-REFERENCE TO RELATED APPLICATIONS

This Application claims the benefit of U.S. Provisional Application Ser. No. 63/470,491 filed Jun. 2, 2023, which is incorporated herein in its entirety.

### TECHNICAL FIELD

The present disclosure generally relates to systems, methods, and devices that enable compression of content that can be represented using one or more two-dimensional (2D) images.

### BACKGROUND

Various 2D compression infrastructures are used to compress image and video content. Three-dimensional content (3D) represented as 3D point clouds, 3D meshes and other 3D models due to their 3D nature generally cannot be encoded using the 3D compression infrastructures and thus cannot take advantage of those infrastructures for encoding and transmission of 3D content.

### SUMMARY

Various implementations disclosed herein include devices, systems, and methods that represent 3D content (e.g., a 3D model, 3D environment, or 3D video) as a set of 2D images (and associative metadata) that can utilize 2D compression infrastructures. For example, a 3D environment may be represented by RGB-D data including an RGB image and a corresponding depth image (an image in which each pixel relates to a distance between an image plane and a corresponding object in the RGB image). Each of these images (i.e., the RGB image and the depth image) may be separately compressed using a 2D compression infrastructure. However, doing so may result in artifacts when the compressed content is used to regenerate the 3D environment, e.g., due to differences in the way the related RGB and depth data are compressed.

Various implementations disclosed herein include devices, systems, and methods that enable compression of content such as 3D content that may be represented by multiple related 2D images/maps (and associative metadata). Some implementations generate a representation of 3D content that is a single 2D data set (e.g., a single 2D image) and associative metadata. The single 2D image may be generated by combining multiple 2D data sets (e.g., multiple images with pixel values having x, y positions) corresponding to different (but positionally-related) attributes of the 3D content. The 2D data sets may include images such as, inter alia, a texture image, a depth image, a transparency image, a confidence image, etc. In some implementations, the 3D content may be a single 3D object. In some implementations the 3D content may include a physical environment, a virtual reality (VR) environment, or an extended reality (XR) environment. In some implementations, the images are aligned to use x,y image coordinates corresponding to related 3D content portions of the 3D content. For example, a top left pixel of a texture image may correspond to the texture/color of a particular portion of a 3D environment and a top left pixel of a depth image may correspond to the depth of that same particular portion of the 3D environment. In some implementations, an additional 2D data set (e.g., a mask component) may be used to describe a partition of a scene with respect to a cluster or an object such as, e.g., a foreground versus a background.

In some implementations, generating the single 2D image may include concatenating components (of the 2D data sets) horizontally, vertically, or on a 2D grid, etc. For example, each component may be stored as a separate sub-picture or in a color plane of a sub-picture (e.g., a depth component may be stored as Y of a YUV color model and a transparency component may be stored as U or V of a YUV color model). In some implementations, placement of the components may be optimized to: maximize component correlations, store related components within a same tile, apply down-sampling/filtering/quantization based on an impact to visual quality, enable spatial scalability and view-dependent rendering, separate components/attributes into random access regions, etc.

In some implementations, a mask component (e.g., an additional 2D data set) describing a partition of a scene (of 3D content) into objects may be used to enable an encoding process. The mask component may be included within the single 2D image. Alternatively, the mask component may be utilized as a separate component with respect to the single 2D image. In some implementations, the mask component may be used for padding (i.e., filling background pixels within additional data sets/images) to improve encoding/compression efficiency.

In some implementations, the single 2D image (and associative metadata) may be encoded into a specialized format for transmission or storage. In some implementations, the single 2D image may be associated with a manifest (e.g., metadata) describing a structure of the single 2D image. The manifest may be used to facilitate encoding by an encoder.

In some implementations, an electronic device has a processor (e.g., one or more processors) that executes instructions stored in a non-transitory computer-readable medium to perform a method. The method performs one or more steps or processes. In some implementations, the electronic device obtains 2D data sets corresponding to different attributes of 3D content. Each of the 2D data sets provides attribute values for locations within a common 2D coordinate system that associates the attribute values for the different attributes with respective portions of the 3D content. In some implementations, a single 2D image is generated by combining the 2D data sets. The attribute values corresponding to the different attributes are combined with the single 2D image. In some implementations, the single 2D image is encoded into a specialized format for transmission or storage.

In accordance with some implementations, a device includes one or more processors, a non-transitory memory, and one or more programs; the one or more programs are stored in the non-transitory memory and configured to be executed by the one or more processors and the one or more programs include instructions for performing or impacting a performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2D illustrate a process for concatenating 2D data sets within a single 2D image, in accordance with some implementations.

FIG. 3 illustrates a view of an original single 2D image and a padded single 2D image generated from the original single 2D image, in accordance with some implementations.

FIG. 4A is a flowchart illustrating an exemplary method that enables compression of 2D map-based video content, in accordance with some implementations.

FIG. 4B is a flowchart illustrating an exemplary method that enables decoding of 2D map-based video content, in accordance with some implementations.

FIG. 5 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

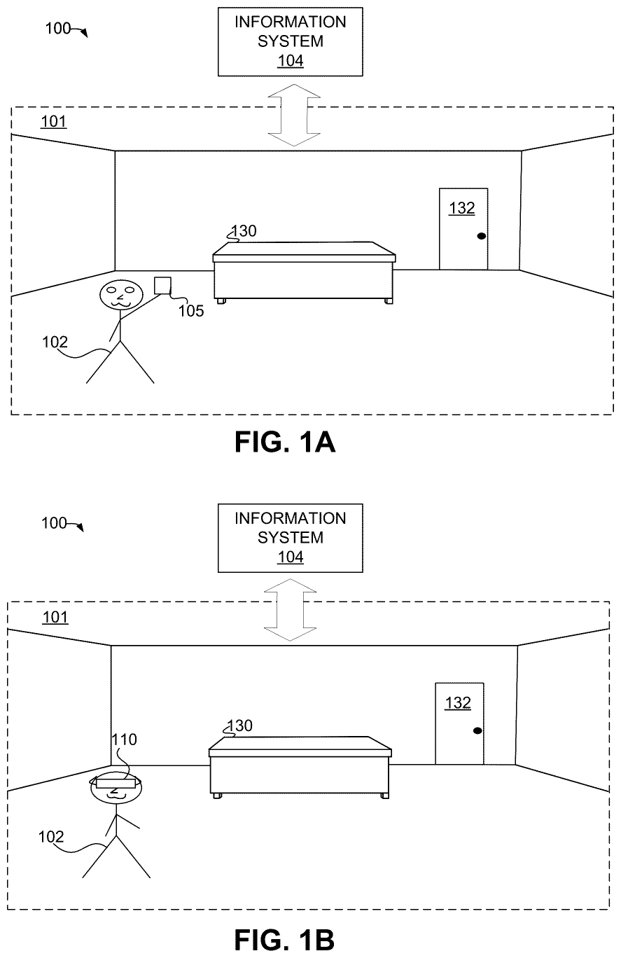

FIGS. 1A-B illustrate an example environment 100 including exemplary electronic devices 105 and 110 operating in a physical environment 101. Additionally, example environment 100 includes an information system 104 (e.g., a device control framework or network) in communication with electronic devices 105 and 110. In the example of FIGS. 1A-B, the physical environment 101 is a room that includes a desk 130 and a door 132. The electronic devices 105 and 110 may include one or more cameras, microphones, depth sensors, or other sensors that can be used to capture information about and evaluate the physical environment 101 and the objects within it, as well as information about the user 102 of electronic devices 105 and 110.

The information about the physical environment 100 and/or user 102 may be used to generate 3D content, e.g., 3D models, 3D environments, 3D videos, etc. The electronic devices 105 and 110 may generate 3D content, e.g., based on their own sensor data, and compress/encrypt, store, and/or send such 3D content to one or more other devices for display. The electronic devices may receive 3D content (e.g., which may be packaged as compressed 2D data sets/images) and display views of the received 3D content.

In some implementations, 2D data sets (e.g., images) such as, inter alia, a texture image, a depth image, a transparency image, a confidence image, etc. are obtained via an electronic device (e.g., devices 105 or 110 or information system 104 of FIGS. 1A and 1B). The 2D data sets may be associated with different attributes of 3D content such as a physical environment, a VR environment, or an XR environment. Each of the 2D data sets may include attribute values for locations within a common 2D coordinate system associating the attribute values (for the different attributes) with respective portions of the 3D content. For example, images may be aligned to utilize common x,y image coordinates corresponding to related 3D content positions.

In some implementations, a single 2D image is generated by combining the 2D data sets. For example, components of the 2D data sets may be concatenated (horizontally, vertically, or on a 2D grid) and stored as separate sub-pictures or in a color plane of a sub-picture. Placement of the components in the single 2D image may be optimized for efficient encoding of the single 2D image into a specialized format for transmission or storage. In some implementations, the single 2D image may be associated with a generated manifest (e.g., metadata) describing a structure and relationships within the single 2D image. The manifest may be used (e.g., as a map) to facilitate encoding by an encoder.

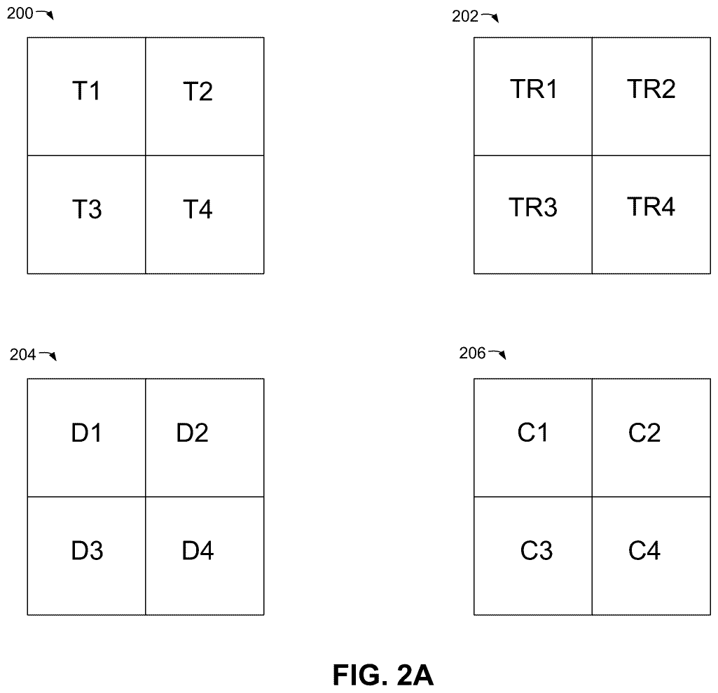

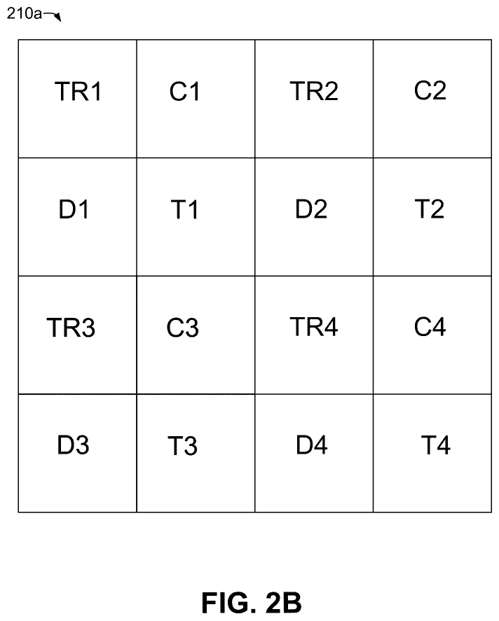

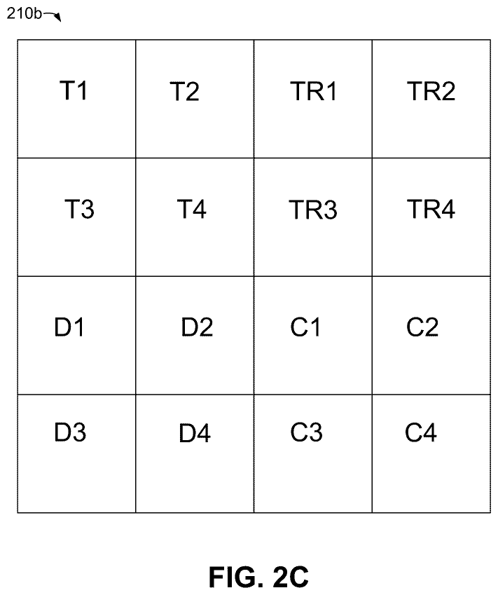

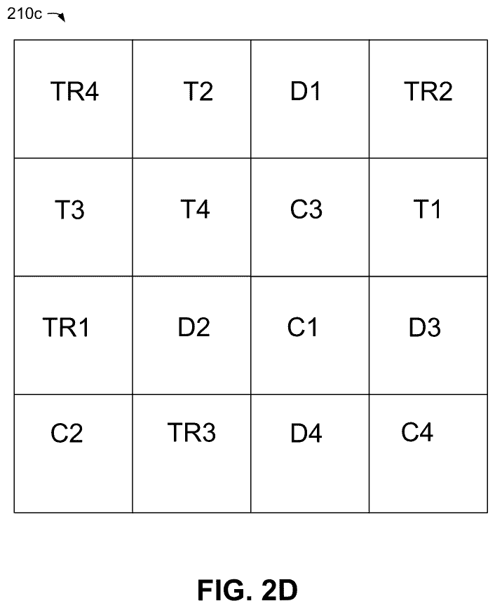

FIG. 2A illustrates 3D (immersive media) video content represented as a multi-map representation comprising 2D data sets 200, 202, 204, and 206, in accordance with some implementations. The 3D content may include, inter alia, a representation of a physical environment, a representation of a VR environment, a representation of an XR environment, etc. The 3D content may provide such representations for a single point in time (i.e., providing static 3D content) or for multiple points in time or frames (i.e., providing dynamic 3D content).

Each of 2D data sets 200, 202, 204, and 206 in FIG. 2A is a separate 2D image. Collectively the 2D data sets represent multiple components such as texture components, depth components, transparency components, confidence components, etc. For example, 2D data set 200 includes texture values T1-T4, each associated with a different pixel (e.g., corresponding to a portion of the 3D video content). 2D data set 202 includes transparency values TR1-TR4 each associated with a different pixel. 2D data set 204 includes depth values D1-D4 each associated with a different pixel. 2D data set 206 includes confidence values C1-C4 each associated with a different pixel. Although, FIG. 2A illustrates 4 groups of 4 values each associated with a pixel, note that any number of values and associated pixels (for example 1000, 2000, 4000, etc.) may be represented in a multi-map representation. The multi-map representation comprising 2D data sets 200, 202, 204, and 206 enable usage of a 2D video/image compression infrastructure (e.g., video standards, APIs, and HW/SW video codecs) for performing an encoding process.

FIG. 2B illustrates 2D data sets 200, 202, 204, and 206 of FIG. 2A concatenated into a single 2D image 210a (comprising a higher resolution, i.e., a greater number of pixels in the single image than in each of the source images) for encoding 2D map-based immersive video content that it represents, e.g., compressing the data into a specialized format for transmission or storage, in accordance with some implementations. Data sets 200, 202, 204, and 206 are concatenated into a single 2D image 210a so that a separate encoding process is not required for each video stream (e.g., each of data sets 200, 202, 204, and 206) associated with each data set type (e.g., depth, texture, transparency, confidence, etc.). Using a single encoding process may reduce artifacts that might otherwise result if multiple different encoding processes are used on the individual source 2D data sets 200, 202, 204, 206.

Data sets 200, 202, 204, and 206 may be concatenated into a single 2D image 210a horizontally, vertically, or with respect to a 2D grid (e.g., as illustrated in FIG. 2B). Each component (of data sets 200, 202, 204, and 206) may be stored in a separate sub-picture (i.e., within a rectangular region of single 2D image 210a). Alternatively, each component (of data sets 200, 202, 204, and 206) may be stored in a color plane of a sub-picture. For example, a depth component may be stored as Y (i.e., a luma component of a YUV color model) and a transparency component may be stored as U or V (i.e., a chroma component of a YUV color model).

As illustrated in FIG. 2B, data sets 200, 202, 204, and 206 have been concatenated into single 2D image 210a with respect to a 2D grid. Texture component values T1-T4, transparency component values TR1-TR4, depth component values D1-D4, and confidence component values C1-C4 (as illustrated in FIG. 2B) are placed within single 2D image 210a such that the components are grouped by related x,y image coordinates corresponding to the related 3D content portions. For example, all of components TR1, C1, D1, and T1 are grouped together within single 2D image 210a. Likewise, components TR2, C2, D2, and T2, components TR3, C3, D3, and T3, and components TR4, C4, D4, and T4 are each grouped together within single 2D image 210a.

In some implementations, a format of an image may utilize a chroma subsampling scheme such as 4:2:0 or 4:2:2 (i.e., a practice of encoding images by implementing less resolution for chroma information than for luma information) such that associated subsampling may be applied to one or multiple components (e.g., texture components, depth components, transparency components, confidence components, etc. of data sets 200, 202, 204, and 206) before placing the components(s) within chroma planes.

In some implementations, placement of components (e.g., within a horizontal structure, a vertical structure a 2D grid structure, etc.) may be optimized such that correlations between components stored within different color planes of a same sub-picture are maximized for encoding. For example, a transparency component may be correlated with a depth component. Therefore, the transparency component and depth component may each be assigned different weight attributes and placed within a same region such that an encoder may leverage the correlation to enable partial decoding random access and improve memory caching by storing related components (i.e., usually used together) in the same tiles to enable partial decoding and random access and improve memory caching.

In some implementations, placement of components (within a horizontal structure, a vertical structure a 2D grid structure, etc.) may be optimized such that down-sampling, filtering, and/or quantization processes may be applied to components based on an impact to the visual quality of 3D rendered content.

In some implementations, placement of components (within a horizontal structure, a vertical structure, a 2D grid structure, etc.) may be optimized such that spatial scalability and view-dependent rendering is enabled by splitting sub-regions of the different components into different sub-pictures.

In some implementations, placement of components (within a horizontal structure, a vertical structure a 2D grid structure, etc.) may be optimized such that components are separated in random access regions.

Optimizing placement of components enables a reduction with respect to encoding or decoding power consumption and memory traffic and storage requirements as component placement optimization may reduce processing related to managing multiple encoding and decoding sessions. Likewise, component placement optimization may allow bitrate control processes to be simplified such that fewer bitstreams (with respect to multiple bitstreams) require processing and multi-stream synchronization is not required as all components are stored within a same 2D image (e.g., single 2D image 210a) thereby increasing overall throughput and reducing the number of decoding sessions necessary.

In some implementations, quality targets may be assigned to components for adjusting encoding parameters. For example, a better relative quality target may be assigned to a texture component with respect to a quality target being assigned to a transparency component. Assignment of a different quality target for each component may be enabled via the following processes:

A first process for assigning quality targets to components may include providing a delta quantization parameter (QP) map for assigning each block of pixels (e.g., 16×16) of a global image, a delta QP that controls quantization errors for each block of pixels. Assigning positive delta QP values to pixel blocks (e.g., associated with texture) enables instructions for guiding a video encoder to provide fewer bits with respect to pixel blocks associated with a depth sub-map. Assigning positive and negative delta QP values may be additionally leveraged to assign a higher and lower number of bits (e.g., negative delta QP map values) to pixel blocks located with respect to object boundaries to achieve improved subjective video quality.

A second process for assigning quality targets to components may include encoding each component or group of components as a separate slice, tile, or region (or set of slices, tiles, or regions) and assigning a different delta QP value to each slice, tile, or region based on component(s) stored within the slices/tiles/regions.

A third process for assigning quality targets to components may include usage of different chroma QP values to control a quality of components stored in various color planes (e.g., U or V planes of a YUV color model).

A fourth process for assigning quality targets to components may include applying pre-filtering, smoothing, scaling or any additional pre-processing procedures including motion-compensated temporal filtering, to different components or groups of components to achieve various compromises in terms of compression efficiency vs. compression quality.

A fifth process for assigning quality targets to components may include adjusting quantization matrices (e.g., via usage of different quantization levels with respect to each coefficient or coefficient group) for efficiently encoding the components. Additionally (with respect to usage of a lagrangian rate distortion optimization (RDO) model within the encoder), lagrangian multipliers may be adjusted to provide optimized encoding with respect to all video coding standards.

In some implementations, encoding parameters may be selected (via a rate distortion optimization block of an encoder) to locate a trade-off between a quality of a pixel block with respect to a number of bits remaining in the pixel block. Therefore, the encoder may perform a rate distortion optimization and component budget allocation process for assigning a different bit budget or adjusting coding parameters (e.g., a disabling a transform) with respect to various components or groups of components based on an impact to a final visual quality of decoded immersive video content. The encoder may additionally execute a multi-pass approach to assess and optimize a local and global importance with respect to various components or groups of components.

The aforementioned placement of components (within a horizontal structure, a vertical structure, a 2D grid structure, etc.) for optimizing correlations between the components may be configured to reduce a computational complexity (with respect to an encoding process) by reusing or guiding intra-inter prediction mode decisions, block structures for prediction/transform, and motion estimation. For example, subsequent to performing motion estimation for a geometry component (e.g., depth), derived motion information may be used directly or may be further refined for additional components. Likewise, the optimized correlations between the components may be configured to enable error concealment with respect to a subset of components based on values of additional components that have been determined to be successfully transmitted.

Some components (e.g., geometry such as depth) may have a significant impact on final visual quality of decoded immersive video content and may influence a user perception and directly impact a quality of additional components such as texture, etc. Therefore, a value of a subset of components may be adjusted based on a reconstructed version (i.e., after encoding/decoding). The adjustment may be performed prior to an encoding process.

For example, a multi-pass encoding process may be performed such that geometry information is compressed first and reconstructed on an encoder side. Subsequently, component values for associated pixels are updated by assigning (to each pixel) a component value of its nearest neighbor(s) in 3D space based on a distance between an original and reconstructed geometry. A same approach may be performed with respect to any related components (e.g., not only geometry vs. texture) and may additionally utilize an approximation of a reconstructed geometry instead of an actual reconstructed version of the geometry thereby eliminating a need to utilize a multi-pass approach.

FIG. 2C illustrates 2D data sets 200, 202, 204, and 206 of FIG. 2A concatenated into an (single 2D) image 210b (comprising a higher resolution, i.e., a greater number of pixels in the single image than in each of the source images). The image 210b may be used to encode the 2D map-based immersive video content that it represents, e.g., compressing the data into a specialized format for transmission or storage, in accordance with some implementations. Data sets 200, 202, 204, and 206 are concatenated into an image 210b so that a separate encoding process is not required for each video stream (e.g., each of data sets 200, 202, 204, and 206) associated with each data set type (e.g., depth, texture, transparency, confidence, etc.). As illustrated in FIG. 2C Texture values T1-T4, transparency values TR1-TR4, depth values D1-D4, and confidence values C1-C4 (as illustrated in FIG. 2C) are placed within image 210b such that the values for different components are grouped by component type. For example, all of texture component values T1-T4 are grouped together within image 210b. Likewise, transparency component values TR1-TR4, depth component values D1-D4, and confidence component values C1-C4 are grouped together within image 210b.

FIG. 2D illustrates 2D data sets 200, 202, 204, and 206 of FIG. 2A concatenated into an (single 2D) image 210c (comprising a higher resolution) for encoding 2D map-based immersive video content into a specialized format for transmission or storage, in accordance with some implementations. As illustrated in FIG. 2D, data sets 200, 202, 204, and 206 have been concatenated into an image 210c with respect to a 2D grid. Texture components T1-T4, transparency components TR1-TR4, depth components D1-D4, and confidence components C1-C4 (as illustrated in FIG. 2C) are placed within image 210a such that the components are grouped by any type of determined relationships between components. For example, components TR4, T2, T3, and T4 are grouped together within image 210c. Likewise, components D1, TR2, C3, and T1, components TR1, D2, C2, and TR3, and components C1, D3, D4, and C4 are each grouped together within image 210c.

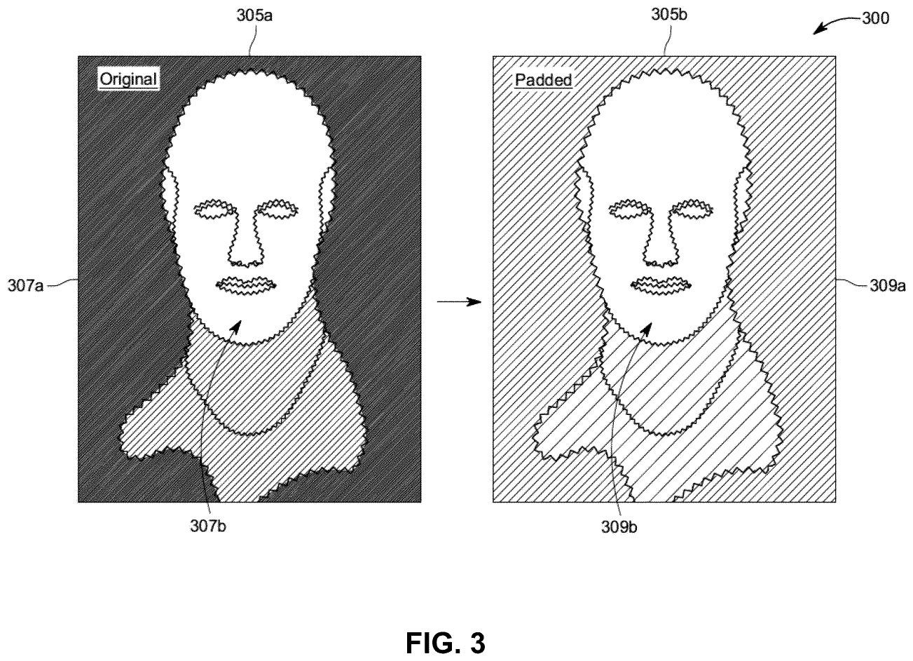

FIG. 3 illustrates a view 300 of an original single 2D image 305a and a padded single 2D image 305b generated from original single 2D image 305a, in accordance with some implementations. View 300 illustrates a process for encoding differing components (e.g., texture, depth, transparency, etc.) by introducing an extra 2D component (i.e., a mask component) describing a partition of a scene with respect to clusters/objects (e.g., foreground vs. background). In some implementations, the process may include assigning a pixel (of original single 2D image 305a) an integer value associated with a specific cluster. For example, pixels with a value of 0 may correspond to a background portion 307a (of original single 2D image 305a) and pixels with a value of 1 may correspond to a foreground portion 307b (of original single 2D image 305a).

In some implementations, the mask component may be encoded as a separate stream. In some implementations, the mask component may be encoded within the same video stream (e.g., within single 2D image 210a, 210b, or 210c of FIGS. 2B-2D) as an extra sub-image or component. The mask component may be encoded via a lossless manner (e.g., all bits of data originally within a file remain after decoding, all bits of data originally within a file in combination with newly introduced bits of data remaining after decoding, etc.) or a lossy manner (i.e., reducing a file size by permanently eliminating redundant information) with respect to a higher bitrate budget to preserve boundaries in an image.

In some implementations, padding techniques may be enabled to fill in background pixels (within additional components) with values that allow each sub-picture to be efficiently encoded. As illustrated in FIG. 3, padded single 2D image 305b does not have sharp transitions (between background portion 309a and foreground portion 309b of padded single 2D image 305b) due to object boundaries and may be more efficiently encoded by a video codec. The extra 2D component enables sharp edges in the depth to be diffused, thereby providing a smoother image of a face within the padded single 2D image 305b. Padding techniques may be applied to additional sub-pictures such as texture, transparency, etc.

In some implementations, the mask component may be enabled (with respect to a decoder side) to: differentiate between foreground pixels and padded background pixels; apply adaptive chroma up-sampling (e.g., conversion from YUV 4:2:0 to YUV 4:4:4) by avoiding mixing samples assigned to different objects; apply adaptive depth interpolation/extrapolation if depth up-sampling is applied; apply object-aware smoothing and other post-processing procedures; etc.

In some implementations, the mask component may be enabled (with respect to a decoder side) to: apply adaptive chroma down-sampling (e.g., conversion from YUV 4:4:4 to YUV 4:2:0); guide a rate distortion optimization (RDO) video encoder module to assign a higher weight to foreground pixels with respect to background pixels or padded pixels; guide a rate allocation and control module to assign a higher bitrate budget to boundary blocks (i.e., blocks shared by two or multiple objects); apply a boundary aware transform on boundary blocks such as shape-adaptive DCT, bandlets, ridgelets, curvelets, contourlets, shearlets, and curvelets; guide intra-inter prediction mode decisions, block structure for prediction/transform, and motion estimation (i.e., track objects and associated boundaries; perform per object error concealment (i.e., use only pixels from the same object to avoid color/depth bleeding between objects); assign or extract metadata to various objects in the scene (e.g., 3D bounding box for collision detection or view-dependent rendering); etc.

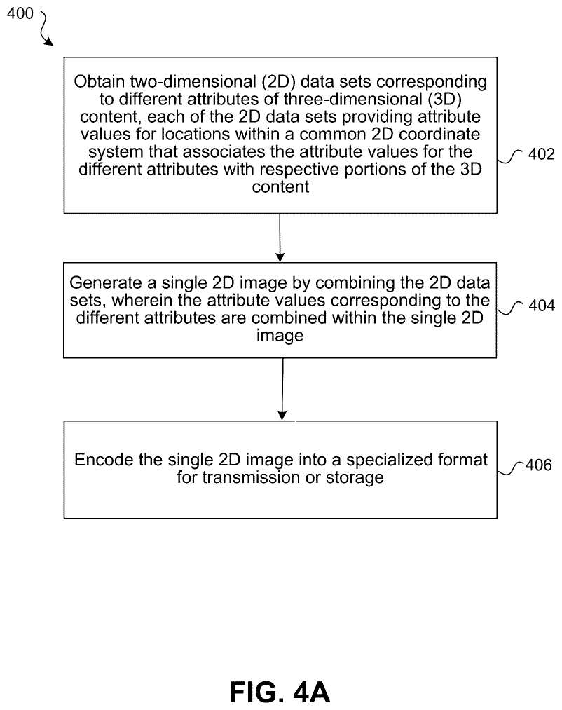

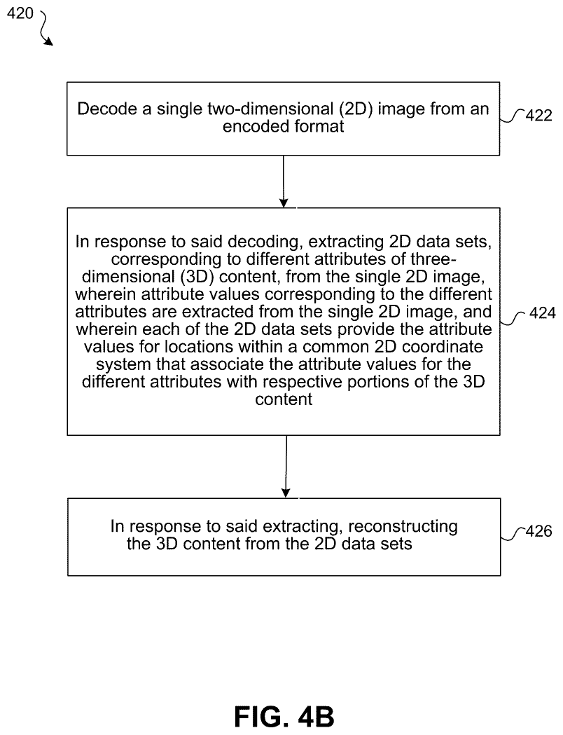

FIG. 4A is a flowchart representation of an exemplary method 400 that enables compression of 2D map-based video content, in accordance with some implementations. In some implementations, the method 400 is performed by a device, such as a mobile device (e.g., device 105 of FIG. 1A), desktop, laptop, HMD, or server device. In some implementations, the device has a screen for displaying images and/or a screen for viewing stereoscopic images such as a head-mounted display (HMD such as e.g., device 110 of FIG. 1B). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

The method 400 enables 3D content (that could otherwise be stored via a multi-map representation using a set of 2D images/videos for depth, texture, transparency, confidence, etc.) to be represented as single 2D image (with higher resolution than a set of 2D images of a multi-map representation). A 2D image format allows for re-use of existing 2D video/image compression infrastructure while the use of a single image may avoid artifacts, avoid sub-optimal compression issues, and reduce power consumption.

At block 402, the method 400 obtains 2D data sets corresponding to different attributes of 3D content. In some implementations, the 3D content include, inter alia, a single 3D object, a 3D representation of a physical environment, a 3D representation of a virtual reality (VR) environment, and a 3D representation of an extended reality (XR) environment.

In some implementations, each of the 2D data sets provides attribute values for locations within a common 2D coordinate system that associates the attribute values for the different attributes with respective portions of the 3D content. In some implementations, the 2D data sets include images such as, inter alia, a texture image, a depth image, a transparency image, a confidence image, etc. In some implementations, the 2D data sets are aligned with respect to x,y data set coordinates corresponding to related portions of the 3D content.

At block 404, the method 400 generates a single 2D image by combining the 2D data sets such that the attribute values corresponding to the different attributes are combined within the single 2D image. In some implementations, generating the single 2D image includes concatenating the different attributes horizontally (within a horizontal structure), vertically (within a vertical structure), or with respect to a 2D grid structure.

In some implementations, each group of common values of the attribute values associated with a same attribute type is stored as a separate sub-image of the single 2D image. In some implementations, each group of common values of the attribute values associated with a same attribute type is stored within a color plane of a sub-image of the single 2D image (e.g., a depth component may be stored as Y (i.e., a luma component of a YUV color model) and a transparency component may be stored as U or V (i.e., a chroma component of a YUV color model)).

In some implementations, placement of each 2D data set within the single 2D image is optimized to maximize correlations between similar attribute characteristics of the different attributes. In some implementations, placement of each 2D data set within the single 2D image is optimized to store similar attribute characteristics of the different attributes within a same tile. In some implementations, placement of each 2D data set within the single 2D image is optimized to apply down-sampling with respect to an impact to a specified visual quality metric (e.g., assigning better relative quality to texture) of the 3D content. In some implementations, placement of each 2D data set within the single 2D image is optimized to apply filtering with respect to an impact to a visual quality of the 3D content. In some implementations, placement of each 2D data set within the single 2D image is optimized to apply quantization with respect to an impact to a visual quality of the 3D content. In some implementations, placement of each 2D data set within the single 2D image is optimized to enable spatial scalability and view-dependent rendering with respect to the 3D content. In some implementations, placement of each 2D data set within the single 2D image is optimized to separate attributes of the different attributes into random access regions.

In some implementations, an additional 2D data set may be generated. The additional 2D data set may be configured to describe a partition of a scene (of the 3D content) into objects (e.g., foreground vs. background). In some implementations, the additional 2D data set is combined within the single 2D image. In some implementations, the additional 2D data set is independent from the single 2D image. In some implementations, the additional 2D data set is used for padding to fill background pixels within the 2D data sets with respect to providing encoding efficiency functionality. In some implementations, the additional 2D data set is a mask component.

In some implementations, the single 2D image is associated with a manifest (e.g., metadata) describing a structure of the single 2D image used to facilitate an encoding or decoding process.

At block 406, the method 400 encodes the single 2D image into a specialized format for transmission or storage.

FIG. 4B is a flowchart illustrating an exemplary method 420 that enables decoding of 2D map-based video content, in accordance with some implementations. In some implementations, the method 420 is performed by a device, such as a mobile device (e.g., device 105 of FIG. 1A), desktop, laptop, HMD, or server device. In some implementations, the device has a screen for displaying images and/or a screen for viewing stereoscopic images such as a head-mounted display (HMD such as e.g., device 110 of FIG. 1B). In some implementations, the method 420 is performed by processing logic, including hardware, firmware, software, or a combination thereof. In some implementations, the method 420 is performed by a processor executing code stored in a non-transitory computer-readable medium (e.g., a memory). Each of the blocks in the method 420 may be enabled and executed in any order.

At block 422, the method 420 decodes a single 2D image from an encoded format.

At block 424, the method 420 (in response to decoding the single 2D image) extracts 2D data sets from the single 2D image. The 2D data sets correspond to different attributes of 3D content. In some implementations, attribute values corresponding to the different attributes are extracted from the single 2D image. In some implementations, each of the 2D data sets provide the attribute values for locations within a common 2D coordinate system that associate the attribute values for the different attributes with respective portions of the 3D content.

At block 426, the method 420 (in response to extracting 2D data sets from the single 2D image) reconstructs the 3D content from the 2D data sets.

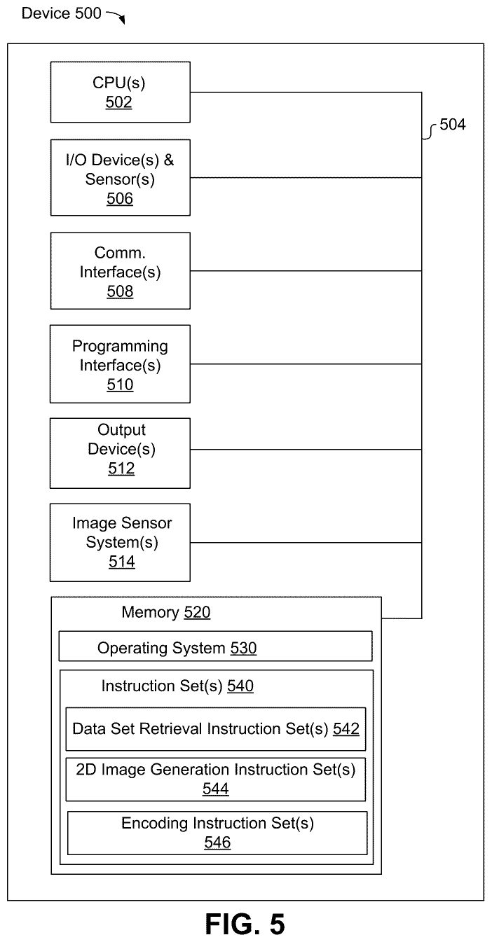

FIG. 5 is a block diagram of an example device 500. Device 500 illustrates an exemplary device configuration for electronic devices 105 and 110 of FIGS. 1A and 1B. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a data set retrieval instruction set 542, a 2D image generation instruction set 544, and an encoding instruction set 548. The instruction set(s) 540 may be embodied as a single software executable or multiple software executables.

The data set retrieval instruction set 542 is configured with instructions executable by a processor to obtain 2D data sets (e.g., a texture image, a depth image, a transparency image, and a confidence image, etc.) corresponding to different attributes of three-dimensional (3D) content.

The 2D image generation instruction set 544 is configured with instructions executable by a processor to generate a single 2D image by combining the 2D data sets.

The encoding instruction set 546 is configured with instructions executable by a processor to encode (and subsequently decode) the single 2D image into a specialized format for transmission or storage.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Returning to FIG. 1, a physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor:
obtaining two-dimensional (2D) data sets corresponding to different attributes of three-dimensional (3D) content, each of the 2D data sets providing attribute values for locations within a common 2D coordinate system that associates the attribute values for the different attributes with respective portions of the 3D content;
generating a single 2D image by combining the 2D data sets, wherein the attribute values corresponding to the different attributes are combined within the single 2D image; and
encoding the single 2D image into a specialized format for transmission or storage.

2. The method of claim 1, wherein the 2D data sets comprise images selected from the group consisting of a texture image, a depth image, a transparency image, and a confidence image.

3. The method of claim 1, wherein the 2D data sets are aligned with respect to x,y data set coordinates corresponding to related portions of the 3D content.

4. The method of claim 1, wherein said generating the single 2D image comprises concatenating the different attributes horizontally, vertically, or with respect to a 2D grid.

5. The method of claim 4, wherein each group of common values of the attribute values associated with a same attribute type is stored as a separate sub-image of the single 2D image.

6. The method of claim 4, wherein each group of common values of the attribute values associated with a same attribute type is stored within a color plane of a sub-image of the single 2D image.

7. The method of claim 1, wherein placement of each 2D data set, of the 2D data sets, within the single 2D image is optimized to maximize correlations between similar attribute characteristics of the different attributes.

8. The method of claim 1, wherein placement of each 2D data set, of the 2D data sets, within the single 2D image is optimized to store similar attribute characteristics of the different attributes within a same tile.

9. The method of claim 1, wherein placement of each 2D data set, of the 2D data sets, within the single 2D image is optimized to apply down-sampling with respect to an impact to a visual quality metric of the 3D content.

10. The method of claim 1, wherein placement of each 2D data set, of the 2D data sets, within the single 2D image is optimized to apply filtering with respect to an impact to a visual quality metric of the 3D content.

11. The method of claim 1, wherein placement of each 2D data set, of the 2D data sets, within the single 2D image is optimized to apply quantization with respect to an impact to a visual quality metric of the 3D content.

12. The method of claim 1, wherein placement of each 2D data set, of the 2D data sets, within the single 2D image is optimized to enable spatial scalability and view-dependent rendering with respect to the 3D content.

13. The method of claim 1, wherein placement of each 2D data set, of the 2D data sets, within the single 2D image is optimized to separate attributes of the different attributes into random access regions.

14. The method of claim 1, further comprising;
generating an additional 2D data set describing a partition of a scene, of the 3D content, into objects.

15. The method of claim 14, wherein the additional 2D data set is combined within the single 2D image.

16. The method of claim 14, wherein the additional 2D data set is independent from the single 2D image.

17. The method of claim 14, wherein the additional 2D data set is used for padding to fill background pixels within the 2D data sets with respect to providing encoding efficiency functionality.

18. The method of claim 14, wherein the additional 2D data set is a mask component.

19. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
obtaining two-dimensional (2D) data sets corresponding to different attributes of three-dimensional (3D) content, each of the 2D data sets providing attribute values for locations within a common 2D coordinate system that associates the attribute values for the different attributes with respective portions of the 3D content;
generating a single 2D image by combining the 2D data sets, wherein the attribute values corresponding to the different attributes are combined within the single 2D image; and
encoding the single 2D image into a specialized format for transmission or storage.

20. A non-transitory computer-readable storage medium storing program instructions executable via one or more processors to perform operations comprising:
obtaining two-dimensional (2D) data sets corresponding to different attributes of three-dimensional (3D) content, each of the 2D data sets providing attribute values for locations within a common 2D coordinate system that associates the attribute values for the different attributes with respective portions of the 3D content;
generating a single 2D image by combining the 2D data sets, wherein the attribute values corresponding to the different attributes are combined within the single 2D image; and
encoding the single 2D image into a specialized format for transmission or storage.
